(19) United States
(12) Patent Application Publication
(10) Pub. No.: US 2014/0099418 A1
(43) Pub. Date: Apr. 10, 2014

(54) CUTTING AND DISPLAY TRAY FOR CUTTING PROPORTIONAL SIZED PIECES OF PIZZA

(71) Applicant: NuVo Grand, LLC, Hudson, OH (US)

(72) Inventor: Greg T. Getzinger, Hudson, OH (US)

(73) Assignee: NuVo Grand, LLC, Hudson, OH (US)

(21) Appl. No.: 14/100,733

(22) Filed: Dec. 9, 2013

Related U.S. Application Data
(63) Continuation-in-part of application No. 12/932,296, filed on Feb. 22, 2011.
Application No. 12/932,296 is a continuation-in-part of application No. 13/555,942, filed on Jul. 23, 2012.
(60) Provisional application No. 61/339,139, filed on Feb. 22, 2010.
(60) Provisional application No. 61/511,723, filed on Jul. 26, 2011.

(51) Int. Cl. B26B 29/06

(52) U.S. Cl. CPC B26B 29/063
USPC 426/520; 269/295

(57) ABSTRACT

A food cutting and display tray comprising a tray body with a plurality of V-shaped cutting grooves formed in a first or second planar surface and radiate from a center point; a circular edge that defines the boundary of said planar surfaces; a gripping groove running about the circumference located between about 0.25″-1″ from said edge; at least one circular centering groove concentric about the center point; and wherein said gripping groove is in a shape selected from a series of discontinuous arc segments, and a continuous circle; wherein the plurality of cutting grooves guide a cutting tool along the grooves to cut a food item into substantially identical, equally-sized segments; wherein the tray material comprises food safe and/or NSF-approved materials that will withstand temperatures up to about 350° F.; and wherein the plurality of cutting grooves facilitate the emphasis, when displayed, that the slices are of equal size.

### CROSS REFERENCE TO RELATED APPLICATIONS

This application is a continuation-in-part of, and claims the benefit of, U.S. patent application Ser. No. 12/932,296, filed February 22, which is entitled “Method and System For More Accurately Determining Nutritional Values and Reducing Waste of Food Items,” which claims the benefit of provisional application Ser. No. 61/339,139 filed Feb. 22, 2010, which is entitled “Method and System For More Accurately Determining Nutritional Values and Reducing Waste of Food Items” and are incorporated herein by reference; and is a continuation-in-part of, and claims the benefit of, U.S. patent application Ser. No. 13/555,942, filed July 23, 2012, which is entitled “System Device And Method Of Using A Proportional Cutting Device To Cut Equal Size Slices Of Pizza,” which claims the benefit of provisional application Ser. No. 61/511,723 filed Jul. 26, 2011, which is entitled “System Device And Method Of Using A Proportional Cutting Device To Cut Equal Size Slices Of Pizza” and are incorporated herein by reference.”

### FIELD OF THE INVENTION

The invention relates generally to a display tray for cutting pizzas, pies, cakes, and the like into equal proportions and to a system and method of using the display/cutting tray to cut equal size slices of pizza.

### BACKGROUND OF THE INVENTION

Pizza shops, public and private schools, sports teams, booster clubs, children party centers, hospitals, nursing homes and institutions all have a need for pizzas cut into equal size slices for sale, lunch programs, meals, fund raisers, and the like. When there are equal slices, there are no odd shapes or undersized slices, which typically go unsold. Thus, there is a need for a pizza board to ensure that different size diameter pizzas (e.g., an 8 or 14 inch diameter pizza) can be cut into equal size slices.

Pizza shops or restaurants, especially “New York style” pizza shops, often sell pizza by the slice. These pizzas are sliced into six large 60° slices. Customers select which piece to purchase, and they will typically choose the largest piece to get their money's worth. This practice leads to the smallest pieces going unsold and discarded, resulting in much waste and loss of revenue. On average, 2 out of every 6 slices, or 1/3 of pizzas by the slice, are thrown out. Ensuring that all 6 slices are the exact same size will reduce or eliminate the discarding of the smallest, unsold slices, and thus result in increased revenue and profits.

Various prior art attempts have been developed which include products for cutting pizza and food items into equal slices. Some of these have focused on the board that holds the pizza, while others have focused on the devices for cutting the pizzas. However, all of those prior art attempts have various limitations and disadvantages, and the present invention provides improvements over these prior art devices.

Further, nutritional studies indicate that many popular foods eaten in the US are wedge-shaped (e.g., pizza, cakes, and pies), and these foods and portion sizes affect the amount of saturated fat and sugar that are consumed and that they are associated with degenerative health conditions. Thus, it is important that amounts of wedge-shaped foods reported in food consumption surveys be as accurate as possible (See e.g., Journal of the American Dietetic Association, Mar. 14, 2006). However, the standard techniques for measuring portion sizes of wedge shaped foods are often inaccurate and consequently the invention discussed herein can be used to eliminate those issues.

U.S. Pat. No. 4,100,676 to Ferguson teaches a board with rectangular score lines or channels designed to achieve equal slices and this device is shown in prior art FIGS. 1-3. The pizza cutting board base 10 has two oppositely facing flat planar surfaces. Each of the flat surfaces has straight slots 40, 42, 44 and 46 formed on the board which intersect to subdivide the surface into a plurality of segments. A cutting instrument is drawn through each slot to cut a superimposed flat object, such as a pizza, into pieces. U.S. Pat. No. 2,906,020 issued Sep. 29, 1959 to Welsh teaches a prior art pizza cutting device having a segmented base with a unitary cutter having blades matching the dividing partitions in the base. The device is shown in prior art FIG. 4 FIGS. 5 and 6 illustrate yet another prior art cutting device, namely that taught by U.S. Pat. No. 6,557,260 issued to Morris, May 6, 2003. The Morris device consists of a series of blades that are spaced equidistant around a rim and originating from a central axis. The Morris device is not unlike a “cookie cutter”, but it is for pizzas.

Notwithstanding these prior art devices for cutting equal pizza slices and related applications, there continues to be a need for a low cost, easy to operate system and method, that limits or prevents wear on the device, is easy to clean between uses, that can be used to cut various diameter pizzas, rectangular pizzas, and the like into equal slices, that properly centers the circular and/or rectangular pizza, for example, at the center of the cutting board, that produces a clean cut through the pizza, and the like.

### SUMMARY OF THE INVENTION

Accordingly, the present invention overcomes the limitations of the prior art by providing a display tray that functions as a cutting board or guide utilizing a system of grooves and/or marks for cutting and displaying equal size wedge or pie shaped portions, rectangular shaped, diamond shaped, and the like, of any number of food items, such as, for example, slices of pizza. The cutting board of the present invention is such that it is simple to construct, inexpensive to make and to use, easy to clean between uses, allows the centering of the pizza on the pizza board and many other advantages mentioned below.

Consequently, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

It is an object of the present invention to provide a pizza display tray for cutting and displaying slices of pizza in a way that emphasizes to customers that the pieces are of equal or proportional size.

It is an object of the present invention to provide a pizza proportional cutting device and method that is easy to clean the cutting device between uses and is dishwasher safe.

It is a further object of this invention to provide a pizza proportional cutting device that is easy to manufacture utilizing food-safe and/or eco-friendly materials.

It is an object of the present invention to provide a proportional cutting device and method that allows the user to cut approximately equal size slices of pizza, pies, cakes and the like.

It is yet another object of this invention to provide cutting device that comprises plastic, metal, composite, wooden, a combination thereof, and the like, wherein the proportional cutting device material reduces the premature wear of the proportional cutting device slots.

It is yet a further object of the present invention to align the center of varying size pizzas with a center marked on a proportional cutting device.

It is an additional object of the invention that a proportional cutting device be used in conjunction with a rocker type two handled knife and/or a pizza rolling cutter and/or a knife.

It is an additional object of the invention that a proportional cutting device be used in conjunction with a pizza cutting wheel.

It is another object of the present invention to provide a proportional cutting device system that allows the user to cut approximately equal size food items that are pie shaped, triangular, rectangular and other shaped pieces of cake, pizza, pie and other suitable foods.

It is another object of the present invention to provide a proportional cutting device system that allows the user to cut predetermined size food items that are pie shaped, triangular, rectangular and other shaped pieces of cake, pizza, pie and other suitable foods that are not all equal slices.

It is another object of the present invention to provide a proportional cutting device system that is aesthetically pleasing and can be used to display the sliced pizza, especially to demonstrate that each of the pieces are of essentially equal size.

### BRIEF DESCRIPTION OF THE DRAWINGS

FIG. 1 illustrates a top view of a prior art pizza cutting board having straight, rectangular slots;

FIG. 2 is a cross-sectional view of the prior art board of FIG. 1

FIG. 3 is another cross-sectional view of the prior art board of FIG. 1.

FIG. 4 illustrates a top view of the display and cutting tray according to an embodiment of the present invention;

FIG. 5 is a cross-sectional view, taken along line 8-8′ in FIG. 4, of the invention;

FIG. 6 is a cross-sectional view, taken along line 9-9′ in FIG. 4, of the invention; and

FIG. 7 illustrates a top view of the display tray according to an alternate embodiment of the present invention that includes holding tabs or handles.

### DETAILED DESCRIPTION OF THE INVENTION

One or more implementations of the present invention will now be described with reference to the attached drawings, wherein like reference numerals are used to refer to like elements throughout. The invention relates generally to a display tray that functions as a cutting device or guide for cutting pizzas, pies, cakes, and suitable foods into equal proportions. The cutting/display tray can further include rectangular food items such as garlic breads and submarine sandwich breads. The design of the grooves in combination with the use of a device groove facilitates the cutting and results in equal slices being easily produced.

The cutting board/tray of the present invention can be used with a variety of cutting devices, and so is not limited to any particular cutting device. The board also can be used as a pizza paddle, and so does not require a user to have separate pizza paddles and cutting boards. The board further functions as a serving platter or tray. The grooves or guides are visible when slices are removed, revealing that each slice is essentially the same size.

As seen in FIG. 4, in one embodiment of the present invention comprises an equal slice display tray 700 with a circular board tray body 720, although as discussed herein the device 700 can comprise other shapes. The body 720 has a plurality of radial cutting slots/grooves 704 to facilitate the cutting of a food item, such as pizza.

In the one embodiment illustrated in FIG. 4, a pizza can be placed on a first planar surface 702 of the proportional cutting device/tray 700 (wherein the device is placed on a cutting surface, for example, a table or counter) and a cutting tool (not shown) can be used to slice the pizza into equal pie-shaped segments as desired. It is possible, or even likely, that each slice is not perfectly, exactly identical, but rather that the cut slices or segments are substantially or nearly identical, equally-sized segments, as the topping and amount of cheese and/or sauce will vary from slice to slice. In other words, while each slice may be cut at, for example, a 45° angle, the thickness of the slice and the distribution of toppings can vary. The cutting tool can be, for example, a handle held pizza cutting wheel, a knife, a multiple handle rocker pizza blade, and the like. The slots or grooves 704, 708, 712, are formed, cut, routed, printed, drawn, and the like, into the first planar surface 702 of the device 700 to allow a cutting tool to cut through the pizza.

Circular centering/alignment slots/marks 708 and 712 are alignment references that allow a user to center a pizza on the first planar surface 702 so that a pizza center and a device center are properly aligned. The circular centering slots 708 and 712 are slightly larger in diameter than the diameter of the pizza to be cut. For example, if the pizza to be cut is 8 inches in diameter the circular centering slot may be approximately 8.25 inches in diameter. Once sliced, the pizza may be served and/or displayed on the tray 700. The grooves 704 extend beyond the out edge of a pizza and are visible when a pizza is on the tray. The tray 700 is constructed such that the cutting grooves 704 are clearly visible so that customers can see these grooves when a slice is removed, or even with a whole pizza on the tray 700. The grooves 704 indicate and emphasize to the customer that each piece is of equal size.

Although the circumferential slots 708, 712 are illustrated as being continuous, it is possible to have dashed or interrupted circumferential slots cut or formed in the board to properly center the pizza. In addition, the centering slots can be rectangular, oval, triangular, and any shape known by one of skill in the art. In addition, both sides of various boards can include grooves or slots on each side of them both to cut different numbers of slices. It is further possible to simply print or paint these alignment markings on the surface, rather than cut or carve them as slots or grooves. This would be less expensive, but likely to be less durable than using slots, as these markings would wear or wash away after prolonged use.

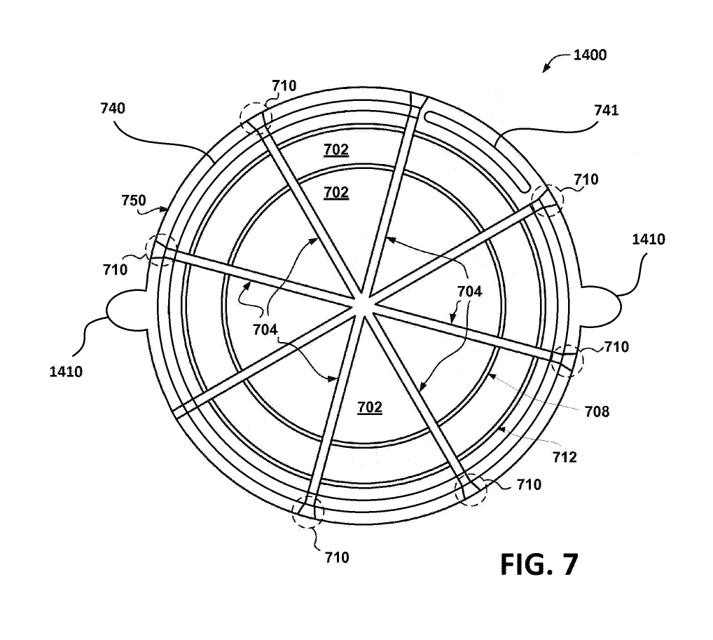

In addition, though not shown, letters or numbers can be cut, routed, printed, laser etched, and the like to indicate the diameter size of the centering grooves in inches, millimeters, etc. In addition, directions, recipes, artwork, cooking instructions, quotes, messages, individual names, company logos, and the like, can be cut, printed, laser etched, burned, etc. into the first planar surface 702, or a second planar surface 703 (see FIGS. 5 and 6) of the device 700. Also, the slots could be replaced by parallel ridges, elevated guides, and the like, and fall within the scope of this invention.

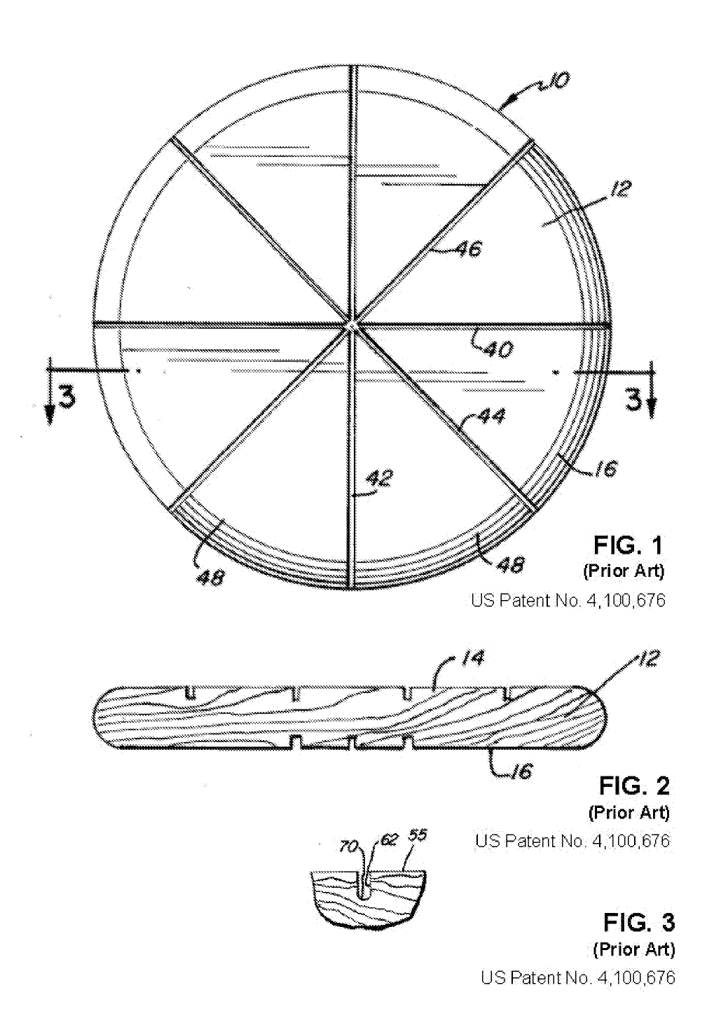

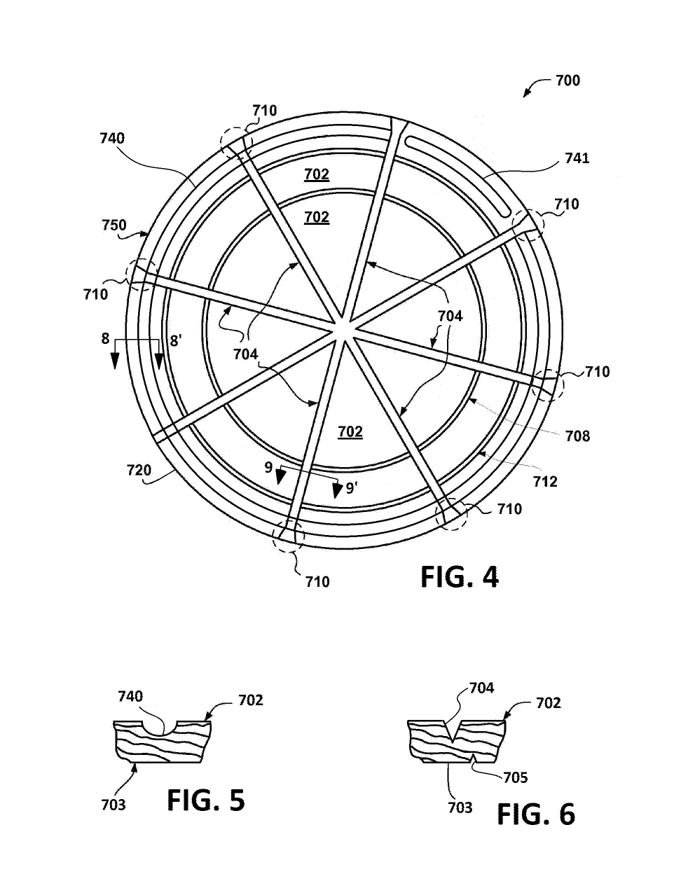

The inventor recognized that prior art pizza boards had slotted grooves that intersected a central point on the pizza boards; however it was still possible to cut unequal slices of pizza, if the pizza center is not properly aligned with respect to the board's center, which is difficult to do. For instance, the Ferguson patent (FIGS. 1-3) suffers from numerous limitations, because the slots as shown in FIG. 3 are likely to result in premature wear. The slots shown in FIGS. 2 and 3 are perpendicular to one another on the board surface and therefore if the cutting tool is not held perpendicular to the plane of the flat board, the cutting tool can cut or slice off the edge of the square groove and result in debris which can become attached to or mixed with the pizza slices. Further, the square slots are difficult to clean in the corners and therefore food particles and debris can become trapped and accumulate in the slots. In addition, there is no indication or reference marks on the pizza board to verify that the pizza center is properly centered with a slot center and therefore the slices can be cut unequally when the pizza is not properly centered on the board with respect to the slot center.

Other prior art cutters, such as Welsh (U.S. Pat. No. 2,906,020) has numerous deficiencies. A pizza placed on the base is cut with one pass of the cutter through the pizza and into the base. However, the Welsh device is complicated, difficult to clean, bulky and expensive. The fact that the device is stationary makes the pizza cutter difficult to clean in between cutting different variety pizzas. The Welsh cutter does not allow for easy cleaning of the cutter in between cutting pizzas because of its size and weight. The Welsh cutter would be used primarily in an area where a large number of pizzas would be cut, such as in a pizza restaurant, a pizza shop, etc. and must be disassembled for cleaning, as well as requiring the more complicated and difficult transfer of the pizza from the base to a carrying or transfer device.

Prior art cutter by Morris (U.S. Pat. No. 6,557,260), the “cookie cutter” for pizzas, has blades that have difficulty cutting the pizza because the cutting blades all cut at one time. It is difficult to apply a large cutting force at any given point on the blades because the applied force on the pizza is distributed across all of the blades. Moreover, while Morris appears to have a centering ring on its top, the operator must position his body directly over top of the device to line it up with the pizza, which is cumbersome, or stand to the side of the device, which introduces a high margin of error and limits its ability to cut equal sized pieces. In addition, the Morris pizza cutter is difficult to clean because many areas of the device are difficult to get to thereby making cleaning challenging. Finally, the materials and intricate design make the device expensive.

Therefore, by adding the radial slots and concentric grooves/marks mentioned supra, the inventor can ensure that the pizza is properly centered in order to cut equal sections of pizza and reduce or eliminate waste from unsold, poorly cut, smaller slices. In addition, the device 700 can be custom made to the buyer's specification comprising the number of pizza sizes, number of slices, board material, board thickness, groove dimension and the like, which is a tremendous advantage over the prior art.

In this embodiment, the device 700 is generally circular in shape and may be constructed from a variety of materials comprising wood, such as ash, hickory, oak, walnut, maple and purple heartwood, chestnut, cherry; bamboo, plastic, porcelain, metal, stone, wood composite materials, bamboo, glass, paper composite (recycled, virgin and combinations thereof, such as resin and paper composite materials), plastic composite materials (recycled, virgin and combinations thereof), food safe materials, NSF approved materials and the like. Preferred embodiments include resin impregnated layers of paper sheets, such as those manufactured by Richlite and Mapletex, and are intended to be included in the term “paper composite materials,” or “paper composite products.” These paper composite products are NSF-approved and safe for food preparation. Further, they can resist temperatures up to 350° F. without warping, melting, or charring/burning. The device can withstand the repeated use in the high temperatures of a commercial dishwasher, such that it is considered “dishwasher safe.” The device 700 can be manufactured utilizing a variety of techniques that include computer numerical control (CNC) machining, routing, injection molding, rotational molding, blow molding, and the like.

The device 700 has a pair of substantially flat planar surfaces 702 and 703 on each side with the first planar face 702 and a second planar face 703 parallel to the first planar face 702, terminating in edge 750 that defines the outer circumference. Although the device 700 is described with parallel faces the inventor contemplated non-parallel planar surfaces and such embodiments are considered part of this invention so that the upper facing surface is at an angle when the device is sitting flat on a table. The diameter of the device 700 is sufficiently large to accommodate the pizza to be cut or proportioned. For example, the device 700 may be large enough to accommodate pizzas ranging from four to sixteen inches in diameter, or larger. In addition, slots, markings and the like can be made on one or both planar surfaces, and the markings, slots and the like, can be the same or different on either planar surface. For example, a first planar surface 702 can be used to cut eight approximately equal slices whereas the second planar surface 703 can be used to cut, via second planar surface cutting grooves 705 (FIG. 6), approximately ten equal slices, or six “New York style” slices.

The device 700 is sufficiently thick (e.g., ¼, 3/8 and 1/2 inches thick) so that the device 700 remains substantially rigid after the centering slots/grooves 708 and 712 and the cutting grooves, 704 are created in the first planar surface 702 and/or cutting grooves 705 (FIG. 6) are created in the second planar surface 703 (FIG. 6) of the device 700. The device 700 shown in FIG. 4 is substantially uniform, however, the device 700 of varying thickness designed to reduce weight, material costs, and the like would still be within the scope of the invention.

The device 700 illustrated in FIG. 4 is further defined by the cutting slots or cutting grooves 704 that each bisect the generally circular surface of the first planar surface 702 with an approximate outer circumference 750. The cutting slots 704 intersect at and radiate out from a central point. The circular centering grooves 708, 712 are centered on and concentric about this central point. The slots 704 and 705 extend into the device 700 a sufficient depth, for example one eighth of an inch, to allow the cutting tool to completely cut through the pizza placed on the first planar surface 702. FIG. 4 shows four of the slots 704 to cut eight approximately equal pieces of pizza but is not intended to be a limit on a number of the slots formed in the device 700. The scope of this invention includes slots of other shapes and sizes including a continuous curve, various arcs, compound angles, concave shapes and the like.

In a preferred embodiment, the cutting grooves 704 are V-shaped as shown in FIG. 6. This V-shape forces the cutting device to move to the bottom or valley of the V, which centers it in the groove 704. This assures the cutting device is always cutting through the exact center of the groove and thus cutting each slice equally. The exact depths of the cutting grooves 704, 705 are not critical; nor are the depths relative to each other critical. The cutting grooves 705 on the second planar surface 703 can be the same depth, deeper, or shallower than the grooves 704 of the first planar surface 702 as shown in FIG. 6, which depicts the first grooves 704 as being deeper than the second grooves 705.

The device has generally circular gripping groove 740 running about its circumference, near the edge of the device. The groove 740 is near the edge, approximately 0.5 inches in from the edge, but this is not critical and can be anywhere from about 1.5 inch to about 0.1 inches in from the edge. This gripping groove 740 is sized to fit a thumb (approximately 0.5 inches wide, but that size is not critical and can be sized larger or smaller), such that when picking up the device, the holder's thumbs naturally and comfortably rest in the groove 740. The preference is for the gripping groove 740 to be about 0.5 inches from the edge, but not at the edge, since the material between the groove and the edge adds leverage and generally aids in gripping and holding the tray. The groove can be an unbroken, continuous, circular groove 740, or, in alternative embodiment, it can be a series of segmented, discontinuous arcs 741 (similar to a dotted line) so as not to cross or intersect the guide cutting grooves 704. The thumb groove 740 is generally a shallow concave indentation as shown in FIG. 5.

In another embodiment, the gripping groove 740 is on the first planar surface 702 while the cutting grooves 705 are on the second planar surface 703. In this embodiment, the fingers interact with the gripping groove 740. This allows the fingers to grip the otherwise flat and possibly slippery underside of the tray. This aids in removing the tray from, for example, pizza display warmers without touching the food or dropping the tray.

While this embodiment teaches this arrangement, the scope of the invention is not limited to parallel and perpendicular slots of equal spacing. Any desirable slot design may be created in the first planar surface 702 of any shaped device such as other geometric or decorative shapes including diamonds, triangles, rectangles, and the like. Additionally, the shape of the proportional cutting device may be circular, square, rectangular, irregular shapes or any other shape desirable to a user. A bevel or taper 710 can be cut, routed and the like into the beginning of the slots 704 to guide the cutting tool more easily into the slots 704.

The cutting tool cutting blade edge is pressed down against the pizza with pizza between the blade edge and the cutting device and rotated along the slot 704, for example, bisecting the pizza. A wider angled guide 710 can be utilized to more easily guide the cutting blade edge into the slot 704. The various cutting tools can comprise knives, cutting wheels, and the like.

In use, the pizza (or any other food item described above) is placed on the cutting/display tray and centered using the centering/alignment reference grooves, and bisected. It is determined if the pizza has been cut into the proper number of slices, in other words, have all of the slices been cut? If all the slices have not been cut, the tray 700 is turned clockwise (or counterclockwise, whichever is preferable to the user) to the next slot 704, wherein the method repeats until all of the slices have been properly bisected for serving. The cutting then ends, and the pizza can be moved to a box, or displayed at a table one the cutting tray.

In another embodiment, the cutting guide is manufactured to fit inside a pizza warmer display. Such displays are used in restaurants, cafes, convenience stores, gas stations, and similar locations. In these establishments, pizza is sold by the slice, and is stored in a transparent, heated display case/vessel, at temperatures around 145° F. Typically, the displays use metal (usually aluminum) trays or screens to hold the pizza. These metal trays and/or screens conduct the heat of the warmer/display and accelerate the pizza drying out. The present invention, in contrast, is a poor conductor, which slows the slices drying out and prolongs the shelf life of the pizza.

In an alternate embodiment of the pizza warmer tray described above, the tray can be manufactured with small gripping points or tabs, which allows the user to grasp and hold the tray as it is being removed from the warmer. FIG. 7 depicts such an alternate embodiment. Because the tray is sized to just fit the pizza, there is little room left for grasping ahold of the tray 1400. The holding tabs 1410 allow the user to remove the tray and carry it to and from the warmer. The size of the tabs 1410 is not critical and can be sized so as to not impede or interfere with the inside the warmer. For example, if the warmer uses a rotating tray, the tabs are sized so as not to contact the sides of the warmer, and thus the tray will rotate freely. These tabs are ideally manufactured as integral part of the whole tray; the tray and the tabs are single piece, a monolithic unit. However, it is possible to produce the tabs separately and attach them after the tray is manufactured.

As with the initial embodiment 700 discussed above, all alternate embodiments are completely customizable. This includes, but is not limited to, diameter of the device, diameter and quantity of centering circles/marks/grooves, thickness of the device, number of cutting grooves/guides, dimensions of grooves/guides, material composition, and/or whether the device is single- or double-sided (i.e. whether there are grooves/guides on one or both sides).

The present invention further includes a method of using a support or display tray to facilitate the extension of life of food items. The device described above can also function as a support tray, wherein the tray is made from a material exhibiting low thermal conductivity and high temperature tolerance. This high temperature tolerance allows the tray to remain in the pizza warmer, or other heated vessel, without melting or warping, while the low thermal conductivity retards the heat transfer to the bottom surface of the pizza, which causes the pizza to dry out at a slower rate. This slower drying results in a longer shelf life of the pizza slices, which, in turn, equates to fewer pizzas being discarded and thus, increased sales and profits. The low thermal conductivity allows a user to, with bare hands, grip and remove the tray from the warmer without burning his or her hand. This allows for quicker removal and/or changing of the pizzas on display since the user does not need to first put on a glove or oven mitt, or use a tool, such as tongs, to remove the hot metal tray/screen. The user would determine the proper length of time in which to store the pizza in the heated display case. Because the tray material can withstand the temperatures for prolonged periods of time (at least over 4 hours), this storage/display time would be determined by the user and/or customers, based on how the pizzas taste and generally how they hold up over time.

Although the invention has been illustrated and described with respect to one or more embodiments, implementations, alterations, and/or modifications may be made to the illustrated examples without departing from the spirit and scope of the appended claims. In particular regard to the various functions performed by the above described components or structures (assemblies, devices, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A food cutting and display tray comprising:
a tray body having a first and second planar surface with a plurality of cutting grooves formed in at least one of said first or second planar surface;
a circular edge that defines the boundary of said first and second planar surfaces;
a gripping groove running about the circumference near said edge;
at least one circular centering groove formed on the at least one of the first or second planar surfaces; and
wherein said cutting grooves radiate from a center point;
wherein said cutting grooves are V-shaped;
wherein said gripping groove is located between about 1 inch to about 1/4 inch from said edge;
wherein said gripping groove is in a shape selected from the group consisting of a series of discontinuous arc segments, and a continuous circle;
wherein the at least one centering groove is concentric about said center point;
wherein the plurality of cutting grooves provide a guide for a cutting tool along the grooves to cut a food item into substantially identical, equally-sized segments;
wherein the tray material comprises food safe and/or NSF-approved materials, plastic, wood, plastic composite materials, wood composite materials, wood and plastic composites, bamboo, porcelain, metal, stone, glass, porcelain, bamboo, recycled paper composite, virgin paper composite materials, resin and paper composite materials, countertop materials, and food safe materials, and combinations thereof;
wherein said tray material will withstand temperatures up to about 350° F. without warping, charring, burning, or deforming; and
wherein the plurality of cutting grooves facilitate the emphasis, when displayed, that the slices are of equal size.

2. The food cutting and display tray of claim 1 wherein said gripping groove is located 1/2 inch from said edge.

3. The food cutting and display tray of claim 1 wherein said tray material can tolerate temperatures of about 185° F. over a period of time of about 4 hours without warping.

4. The food cutting and display tray of claim 1, wherein the device is dishwasher safe.

5. The food cutting and display tray of claim 1 wherein said at least one circular centering groove and said cutting grooves are formed on said first planar surface and said gripping groove is formed on said second planar surface.

6. A method of prolonging the shelf life of food items in a heated vessel comprising providing the support and display tray of claim 1,
placing a food item on said support and display tray;
providing a heated vessel;
placing said tray into said heated vessel;
determining a proper to time to leave said tray inside said vessel; and
removing said tray after said proper time.

7. The method of claim 16 wherein said heated vessel is a pizza warmer display case.

8. The method of claim 16 wherein the removing said tray can be safely performed with a user's bare hands.
